(19) United States
(12) Patent Application Publication
(10) Pub. No.: US 2015/0281724 A1
(43) Pub. Date: Oct. 1, 2015

(54) METHOD AND APPARATUS FOR ENCAPSULATION OF RANDOM ACCESS INFORMATION FOR MEDIA TRANSPORT AND STORAGE

(71) Applicants: ZTE CORPORATION, Shenzhen City, Guangdong (CN); ZTE (USA) INC., Richardson, TX (US); ZTE (UK) LIMITED, Middlesex (GB)

(72) Inventors: Ming Li, Nanjing (CN); Gerard Fernando, Mountain View, CA (US); Ping Wu, Hampshire (GB)

(21) Appl. No.: 14/434,582

(22) PCT Filed: Oct. 9, 2013
(86) PCT No.: PCT/CN2013/084924

§ 371 Date: Apr. 9, 2015

(30) Foreign Application Priority Data
Oct. 10, 2012 (CN) PCT/CN2012/082722

(51) Int. Cl. H04N 19/463; H04L 12/46; H04N 19/174; H04N 19/169; H04N 19/172

(52) U.S. Cl. CPC H04N 19/463; H04N 19/188; H04N 19/172; H04N 19/174; H04L 12/4633

(57) ABSTRACT

A method and apparatus are provided for attaching random access information for video data for purposes of media transport or media storage, thus enabling efficient stream operations to be performed on the video streams. The information is attached to the media transport or storage format header in the form of a descriptor or as a data structure.

### TECHNICAL FIELD

The present invention relates to video coding, and in particular, relates to encapsulation of random access information for video data for purposes of media transport and storage.

### BACKGROUND ART

Nowadays, video application is developing quickly, and due to a developing tendency of higher definition, higher frame rate and higher compression rate, limitations of the current mainstream video compression standard H.264/MPEG-4 Advanced Video Coding (AVC) become prominent.

In view of such a situation, the ITU-T Video Coding Experts Group (VCEG) and ISO/IEC Moving Picture Experts Group (MPEG) are working together in partnership known as Joint Collaborative Team on Video Coding (JCT-VC) for developing a next generation video compression standard, namely the High Efficiency Video Coding (HEVC) standard.

The design of HEVC incorporates the latest state-of-the-art technologies and algorithmic advances to address the persistent demand for broader usage of video content, video migration to broadband networks, diversification of mobile devices, ever-higher resolutions for cameras and displays, and increasingly high video quality. The major goal of the JCT-VC's project is to achieve the same level of video quality with a substantial savings (e.g. reduction by half) relative to the bit rate required by AVC. Initial measurements of the capability of HEVC, at this stage, indicate that its performance is already meeting or exceeding the targets set by this goal.

So far, the HEVC text specification draft 7 has been issued. But content of the HEVC standard is still being modified and enriched. The first edition of the HEVC standard is expected to be finalized in January 2013, resulting in an aligned text that will be published by both ITU-T and ISO/IEC.

At present, there is a need for a technique allowing more efficient operations on video streams to be performed.

### SUMMARY OF THE INVENTION

The purpose of the present invention is to provide a method, apparatus, and system for processing video data, which enables more efficient operations on video streams to be performed.

To achieve the purpose, the present invention provides a method for processing video data, comprising:

attaching random access information for video data;

wherein the random access information comprises random access point (RAP) information and stream access point (SAP) information.

Preferably, the method further comprises storing the video data or transporting the video data over a network after the attachment.

Preferably, the RAP information comprises one or more of the following RAP types:

RAP type 1: clean random access (CRA) picture;

RAP type 2: broken link access (BLA) picture;

RAP type 3: BLA picture with no associated tagged for discard (TFD) pictures;

RAP type 4: BLA picture with no leading pictures;

RAP type 5: instantaneous decoding refresh (IDR) picture with no leading pictures;

RAP type 6: IDR picture which can have leading pictures.

Preferably, the SAP information comprises one or more of the following SAP types:

SAP type 1: all pictures are decodable starting from that point, and first decoded picture has lower presentation time stamp (PTS) than pictures decoded later;

SAP type 2: all pictures are decodable starting from that point, and a picture decoded later has lower PTS than the first decoded picture;

SAP type 3: all pictures are not decodable starting from that point, but first picture is decodable, and a non-decodable picture has lower PTS than the first decoded picture.

Preferably, the random access information is indicated by one or more flags.

Preferably, the random access information is physically attached to the video data.

Preferably, the random access information is virtually attached for the video data.

Preferably, the step of attaching the random access information for the video data comprises:

including the random access information in a separate file or data structure; and

associating the random access information to the video data.

Preferably, the random access information is associated to the video data by one or more pointers.

Preferably, the step of attaching the random access information for the video data comprises:

including the random access information in a data structure if the video data is to be stored; or

including the random access information in a data header or descriptor if the video data is to be transported over a network.

Preferably, the video data is a compressed video stream.

To achieve the above purpose, the present invention further provides an apparatus for processing video data, comprising

an attaching module configured to attach random access information for video data;

wherein the random access information comprises random access point (RAP) information and stream access point (SAP) information.

Preferably, the apparatus further comprises a storing module configured to store the video data or transport the video data over a network after the attachment.

Preferably, the attaching module is further configured to use one or more flags to indicate the random access information.

Preferably, the attaching module is configured to physically attach the random access information to the video data.

Preferably, the attaching module is configured to virtually attach the random access information for the video data.

Preferably, the attaching module is configured to attach the random access information by way of:

including the random access information in a separate file or data structure; and

associating the random access information to the video data.

Preferably, the attaching module is configured to use one or more pointers to associate the random access information to the video data.

Preferably, the attaching module is configured to attach the random access information by way of:

including the random access information in a data structure if the video data is to be stored; or

including the random access information in a data header or descriptor if the video data is to be transported over a network.

To achieve the above purpose, the present invention further provides a system for processing video data, comprising:

an apparatus for generating video data; and

an apparatus as defined above.

The method, apparatus and system for processing video data for purposes of media transport or media storage provided in the present invention enable efficient stream operations on video streams, such as trick play functions, to be performed.

### BRIEF DESCRIPTION OF THE DRAWING

FIG. 1 illustrates a flow chart of a method according an embodiment of the present invention.

FIG. 2 illustrates the structure of an apparatus for processing video data according another embodiment of the present invention.

FIG. 3 illustrates a system according another embodiment of the present invention.

### PREFERRED EMBODIMENTS OF THE PRESENT INVENTION

Random access of a video stream refers to the act of starting the decoding process for a video stream at a point other than the beginning of the stream. Knowledge of the random access nature of a video stream enables operations on the video stream to be performed. Such operations include trick play functions.

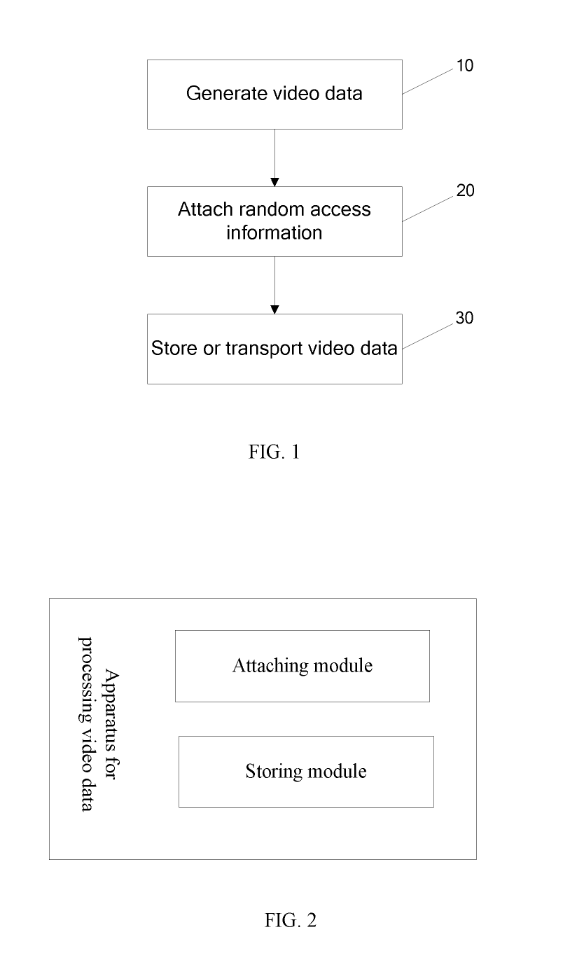

FIG. 1 shows the flow of a method for attaching random access information for video data according to an embodiment of the present invention. The method includes the following steps:

Step 10: video data such as a video stream is generated. The video stream is preferably compressed.

Step 20: random access information is attached for the generated video data.

Step 30: the video data is stored or transported over a network.

For a compressed video stream random access information falls into two categories—namely random access point (RAP) information and stream access point (SAP) information. It is possible to distinguish between SAP and RAP information. There are several SAP types and several RAP types in the HEVC video compression standard in ISO/MPEG. An embodiment of the present invention provides methods for independently identifying SAP types and RAP types. In an example, the SAP and RAP types may be indicated by flags.

Below are more details on the SAP and RAP types that require signaling for HEVC video compressed data:

RAP type 1: CRA picture;

RAP type 2: BLA picture;

RAP type 3: BLA picture with no associated TFD pictures;

RAP type 4: BLA picture with no leading pictures;

RAP type 5: IDR picture with no leading pictures;

RAP type 6: IDR picture (which may have leading pictures);

SAP type 1:
All pictures are decodable starting from that point
First decoded picture has lower PTS than pictures decoded later.

SAP type 2:
All pictures are decodable starting from that point
A picture decoded later has lower PTS than the first decoded picture.

SAP type 3:
All pictures are NOT decodable starting from that point
First picture is decodable
A non-decodable picture has lower PTS than the first decoded picture.

The following acronyms are used in the above list:
(1) RAP: Random Access Point;
(2) SAP: Stream Access Point;
(3) CRA: clean random access (CRA) picture: A RAP picture for which each slice has nal_unit_type equal to CRA_NUT;
(4) PTS: Presentation time stamp;
(5) BLA: broken link access (BLA) picture (BLA access unit: An access unit in which the coded picture is a BLA picture);
(6) IDR: instantaneous decoding refresh (IDR) picture: A RAP picture for which each slice has nal_unit_type equal to IDR_W_LP or IDR_N_LP;
(7) TFD: tagged for discard.

Compressed video data is commonly transported over a network or it is stored. For both cases knowledge of the random access nature of the associated video payload helps in efficient stream level processing. This information may be physically attached to the compressed video data. Alternatively, such information may be virtually attached. In the context of media transport and storage, one example of virtual attachment is where random access information is available in a separate file or data structure, and where there are pointers or similar mechanisms to associate the random access information to the video stream.

Attachment of random access information with the compressed video data into the media transport or media storage format is referred to as encapsulation. According to an embodiment of the present invention, attachment of random access information may be in the form of data headers or descriptors for media transport purposed, and data structures for media storage purposes.

The present invention further provides an apparatus for performing the afore-mentioned random access information attachment operation. According to an embodiment as illustrated in FIG. 2, the apparatus for attaching random access information for video data comprises an attaching module configured to attach random access information for generated video data. The generated video data may be a compressed video stream. The apparatus further comprises a storing module, after the attachment of the random access information, the video data is stored or transported over a network by the storing module.

Further, the attaching module may be further configured to use one or more flags to indicate the random access information. The attaching module may be configured to physically attach the random access information to the generated video data, or to virtually attach the information. In the context of media transport and storage, one example of virtual attachment is to include the random access information in a separate file or data structure, and to use pointers or similar mechanisms to associate the random access information to the video stream. The attaching module may be configured to attach the random access information in the form of data headers or descriptors for media transport purpose, and data structures for media storage purpose.

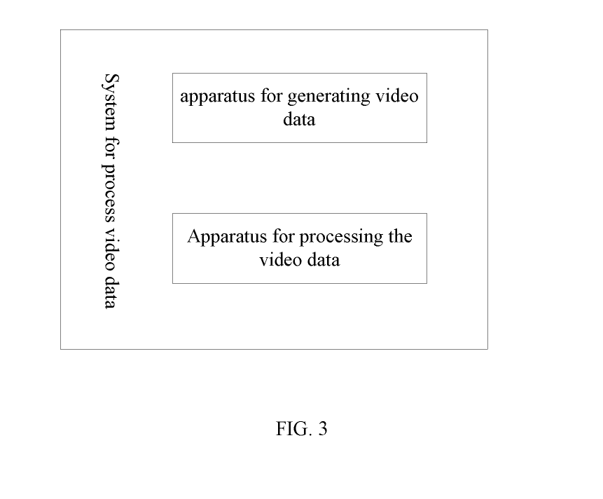

The present invention further provides a system for processing video data, according to an embodiment as illustrated in FIG. 3, the system comprising: an apparatus for generating video data; and an apparatus for processing the video data as defined above.

A person skilled in the art should understand that the method and apparatus in the present invention may be realized by hardware, software or firmware. For example, they may be realized by a general computing device(s), or computing device executable programs and thereby can be stored in storage media, or integrated circuits.

What is described in the above are just preferred embodiments of the present invention, and is not intended to limit the present invention. To a person skilled in the art, the present invention may have various modifications and variations. Without departing from the essence and principle of the present invention, all the modifications, equivalent substitutions, improvements, etc., shall all fall within the protection scope of the present invention.

### INDUSTRIAL APPLICABILITY

The method and apparatus for attaching random access information for video data for purposes of media transport or media storage provided in the present invention enable efficient stream operations on the video streams, such as trick play functions, to be performed. The present invention is applicable to the video coding field.

1. A method for processing video data, comprising:
attaching random access information for video data;
wherein the random access information comprises random access point (RAP) information and stream access point (SAP) information.

2. The method as claimed in claim 1, further comprising storing the video data or transporting the video data over a network after the attachment.

3. The method as claimed in claim 1, wherein the RAP information comprises one or more of the following RAP types:
RAP type 1: clean random access (CRA) picture;
RAP type 2: broken link access (BLA) picture;
RAP type 3: BLA picture with no associated tagged for discard (TFD) pictures;
RAP type 4: BLA picture with no leading pictures;
RAP type 5: instantaneous decoding refresh (IDR) picture with no leading pictures;
RAP type 6: IDR picture which can have leading pictures.

4. The method as claimed in claim 1, wherein the SAP information comprises one or more of the following SAP types:
SAP type 1: all pictures are decodable starting from that point, and first decoded picture has lower presentation time stamp (PTS) than pictures decoded later;
SAP type 2: all pictures are decodable starting from that point, and a picture decoded later has lower PTS than the first decoded picture;
SAP type 3: all pictures are not decodable starting from that point, but first picture is decodable, and a non-decodable picture has lower PTS than the first decoded picture.

5. The method as claimed in claim 1, wherein the random access information is indicated by one or more flags.

6. The method as claimed in claim 1, wherein the random access information is physically attached to the video data.

7. The method as claimed in claim 1, wherein the random access information is virtually attached for the video data.

8. The method as claimed in claim 7, wherein the step of attaching the random access information for the video data comprises:
including the random access information in a separate file or data structure; and
associating the random access information to the video data.

9. The method as claimed in claim 8, wherein the random access information is associated to the video data by one or more pointers.

10. The method as claimed in claim 1, wherein the step of attaching the random access information for the video data comprises:
including the random access information in a data structure if the video data is to be stored; or
including the random access information in a data header or descriptor if the video data is to be transported over a network.

11. The method as claimed in claim 1, wherein the video data is a compressed video stream.

12. An apparatus for processing video data, comprising
an attaching module configured to attach random access information for video data;
wherein the random access information comprises random access point (RAP) information and stream access point (SAP) information.

13. The apparatus as claimed in claim 12, further comprising a storing module configured to store the video data or transport the video data over a network after the attachment.

14. The apparatus as claimed in claim 12, wherein the attaching module is further configured to use one or more flags to indicate the random access information.

15. The apparatus as claimed in claim 12, wherein the attaching module is configured to physically attach the random access information to the video data.

16. The apparatus as claimed in claim 12, wherein the attaching module is configured to virtually attach the random access information for the video data.

17. The apparatus as claimed in claim 16, wherein the attaching module is configured to attach the random access information by way of:
including the random access information in a separate file or data structure; and
associating the random access information to the video data.

18. The apparatus as claimed in claim 17, wherein the attaching module is configured to use one or more pointers to associate the random access information to the video data.

19. The apparatus as claimed in claim 12, wherein the attaching module is configured to attach the random access information by way of:
including the random access information in a data structure if the video data is to be stored; or
including the random access information in a data header or descriptor if the video data is to be transported over a network.

20. A system for processing video data, comprising:
an apparatus for generating video data; and
an apparatus as defined in claim 12.
